(19) United States
(12) Patent Application Publication
(10) Pub. No.: US 2007/0289770 A1
(43) Pub. Date: Dec. 20, 2007

(54) Two-piece clip

(75) Inventor: Takashi Koike, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: PIOLAX INC., Yokohama-shi (JP)

(21) Appl. No.: 11/802,847

(22) Filed: May 25, 2007

(30) Foreign Application Priority Data
May 26, 2006 (JP) P2006-146700

(51) Int. Cl. F16L 5/00

(52) U.S. Cl. 174/153 G

(57) ABSTRACT

A two-piece clip includes: a grommet; and a pin-shaped member, wherein: the grommet includes a leg portions, an elastic engagement member formed on a side wall through a slit, and a sliding protrusion; the pin-shaped member includes an insertion member to be inserted into the slit; the insertion member is provided on an inner side face with a cam, the cam including: a first slope portion sloped for guiding the sliding protrusion inward of the leg portion; a crest portion at the trailing end of the first slope portion for positioning the sliding protrusion to the most inside of the leg portion; and a second slope portion sloped for guiding the sliding protrusion outward of the leg portion; and an open portion for not regulating the sliding protrusion.

### BACKGROUND OF THE INVENTION

1. Field of the Invention

The present invention relates to a two-piece clip, which is configured of a grommet and a pin for fixing a panel member on a compartment member of an automobile and for connecting plural panel members to each other.

2. Description of the Related Art

In JP-UM-A-2-47414, there is disclosed a two-piece clip (or a joint clip) of this kind of the prior art, which is provided with a grommet (or a clip body) and a pin. The grommet includes: an annular flange portion (or a head portion) having a pin inserting hole; leg members depending from the peripheral edge of the pin inserting hole, divided into a plurality through slits and having its leading end portions bent to the inside; and elastic retaining members so formed on the side faces of the leg members as to be warped through C-shaped slits and having projections formed at their leading end portions. The pin includes: a stem portion; an umbrella type insertion head portion formed at the leading end of the stem portion; and a bulging stem portion disposed at a predetermined axial spacing from the insertion head portion and having groove portions in its outer periphery.

When the leg members of the grommet are inserted into the mounting hole of a first plate member, the elastic retaining members are pushed and warped to the inner side by the inner periphery of the mounting hole and are elastically restored when they come out to the back side of the mounting hole so that projections engage with the peripheral edge of the back side of the mounting hole thereby to fix the grommet tentatively in the first plate member. Next, the grommet is inserted into the mounting hole of a second plate member, and the pin is inserted into the grommet. Then, the plural leg members are pushed and widened by the bulging stem portion, and the leading end portions of the leg members are fitted in the groove portions so that the leg members engage with the back side peripheral edges of the mounting hole of the second plate. As a result, the first plate member and the second plate member are clamped and connected by the flange portion and the leg members of the grommet. When the pin is pushed from this connected state, the leading end portions of the leg members come out from the groove portions so that the individual leg members are narrowed. As a result, the clip can be removed from the mounting hole of the second plate member so that the first plate member can be removed from the second plate member.

### SUMMARY OF THE INVENTION

For the reasons to replace or discard the clip, it is desired to remove the two-piece clip from the mounting hole. In the case of the aforementioned two-piece clip, however, the projections formed at the leading end portions of the elastic retaining members are left in engagement with the back side peripheral edges of the first plate member even after the first plate member was removed from the second plate member. Even if, therefore, the grommet is pulled from the mounting hole by gripping the flange portion, the projections are caught by the mounting hole peripheral edge thereby to make it difficult to remove the clip from the first member.

It is, therefore, an object of the invention to provide a two-piece clip, which can be simply removed, if necessary, from a mounting hole

In order to achieve the aforementioned object, according to a first aspect of the invention, there is provided a two-piece clip including a grommet; and a pin-shaped member adapted to be inserted into and extracted from the grommet, wherein: the grommet includes: a flange portion abutting against a surface side peripheral edge of a mounting hole formed in a mounting object member and having an insertion hole that the pin-shaped member is inserted; a leg portion extending in a cylindrical shape from the insertion hole peripheral edge of the flange portion; an elastic engagement member formed on at least one side walls of the leg portion through slit as to be warped to the inner side and the outer side of the leg portion, the elastic engagement member engaging with a back side peripheral edge of the mounting hole; and a sliding protrusion protruding from at least one side portion of the elastic engagement member; the pin-shaped member includes an insertion member to be inserted into the slit that is related to the sliding protrusion of the leg portion; the insertion member is provided on an inner side face with a cam; the cam includes: a first slope portion sloped for guiding the sliding protrusion inward of the leg portion; a crest portion at the trailing end of the first slope portion for positioning the sliding protrusion to the most inside of the leg portion; and a second slope portion sloped for guiding the sliding protrusion outward of the leg portion; and an open portion for not regulating the sliding protrusion; the first slope portion, the crest portion, the second slope portion and the open portion are continuously formed from a leading end side to a root end side of the insertion member; and when the sliding protrusion is positioned at the crest portion, the elastic engagement member is warped so inward as unengaged with the mounting hole.

According to the aforementioned invention, the insertion member is positionally adjusted to the slit, and the pin-shaped member is pushed into the grommet. Then, the sliding projection abuts against the first slope portion of the cam, and the elastic engagement member is warped inward of the leg portion. When the sliding protrusion reaches the crest portion, the elastic engagement member is warped inward to the maximum. When the sliding protrusion abuts against the second slope portion, the elastic engagement member again opens outward. When the sliding protrusion reaches the open portion, the elastic engagement member is so opened outward to the maximum as can be warped inward.

Therefore, the pin-shaped member is inserted so far into the grommet that the sliding protrusion reaches the open portion and the leg portion of the grommet is inserted in that state into the mounting hole of the mounting object member. Then, the elastic engagement member passes, while being warped to the inner side, through the mounting hole, and come into engagement with the back side peripheral edge of the mounting hole. As a result, the mounting object member is clamped between the flange portion of the grommet to engage with the surface side peripheral edge of the mounting hole and the elastic engagement member to engage with the back side peripheral edge of the mounting hole, so that the two-piece clip (as will be simply called the “clip”) can be fixed in the mounting object member.

When it is desired to remove the clip, the pin-shaped member is extracted from the grommet. Then, the sliding protrusion moves the second slope portion backward of the aforementioned direction so that the elastic engagement member is gradually warped inward of the leg portion. Then, the sliding protrusion abuts against the crest portion so that the elastic engagement member can be warped inward to the maximum. In this state, the elastic engagement member is warped inward to an extent not to engage with the mounting hole, so that the leg portions of the grommet can be smoothly extracted to remove the clip easily.

According to a second aspect of the invention, there is provided a two-piece clip according to the first aspect, wherein in a first engaging state, the pin-shaped member is tentatively held in the grommet in a state where the pin-shaped member is pushed into the grommet so that the sliding protrusion is positioned at the crest portion.

According to the second aspect of the invention, the pin-shaped member can be tentatively held in the grommet in the first engaging state thereby to keep the state, in which the elastic engagement member is warped inward to the maximum. As a result, the leg portion can be more reliably extracted from the mounting hole to remove the clip.

According to a third aspect of the invention, there is provided a two-piece clip according to the second aspect, further including a lock portion for abutting against the elastic engagement member thereby to regulate an inward warpage of the elastic engagement member when the pin-shaped member is pushed to the maximum into the grommet, the lock portion being provided with the pin-shaped member.

According to the third aspect of the invention, the clip is inserted into the mounting hole thereby to bring the elastic engagement member into engagement with the back side peripheral edge of the mounting hole. When the pin-shaped member is pushed in this state to the maximum into the grommet, the leg portion abuts against the elastic engagement member thereby to regulate the inward warpage of the elastic engagement member. As a result, even if a force transverse of the mounting hole acts on the clip, the elastic engagement member is not warped to the inner side, so that the clip can be reliably kept in the fixed state while being prevented from rattling or coming out.

According to a fourth aspect of the invention, there is provided a two-piece clip according to the third aspect, wherein: in a second engaging state, the pin-shaped member is tentatively held in the grommet in the state where the sliding protrusion is positioned at the open portion and where the lock portion does not abut against the elastic engagement member; in a third engaging state, the pin-shaped member is held in the grommet in the state where the sliding protrusion is positioned at the open portion and where the lock portion abuts against the elastic engagement member; and the holding force corresponding to the second engaging state is set stronger than the resisting force, which is generated by the sliding contact between the elastic engagement member and an inner periphery of the mounting hole when the leg portion of the grommet is pushed while pushing the pin-shaped member into the mounting hole in the state where the pin-shaped member is tentatively held in the grommet in the second engaging state.

According to the fourth aspect of the invention, the leg portion of the grommet is pushed into the mounting hole while pushing the pin-shaped member in the state where the pin-shaped member is tentatively held in the grommet in the second engaging state. At this time, however, the pin-shaped member is not pushed into the grommet, because the holding force is set stronger than the resisting force which is generated by the sliding contact between the elastic engagement member and the inner periphery of the mounting hole. As a result, the elastic engagement member can be warped inward to pass through the mounting hole and comes into engagement with the back side peripheral edge of the mounting hole thereby to fix the clip. When the pin-shaped member is further pushed in this state into the grommet, the lock portion abuts against the inner side of the elastic engagement member thereby to regulate the inward warpage of the elastic engagement member and to hold the pushed position of the pin-shaped member relative to the grommet in the third engaging state.

According to a fifth aspect of the invention, there is provided a two-piece clip according to the fourth aspect, further including: a first protrusion; a second protrusion; a third protrusion; a first projection; and a second projection, wherein: one of the insertion member and the leg portion includes the first protrusion, the second protrusion and the third protrusion formed at a predetermined spacing along the pushing direction from the leading end side of the insertion member or the root end side of the leg portion; the other of the insertion member and the leg portion includes groove portions, into which the first protrusion, the second protrusion and the third protrusion are slidably inserted, and the first projection and the second projection, which are formed on the inner side of the groove portions at a predetermined spacing along the pushing direction from the leading end side of the insertion member or the root end side of the leg portion; in the first engaging state, the third protrusion is engaged with a front side of the first projection, and the second protrusion are engaged with a back side of the first projection; in the second state, the third protrusion is engaged with the back side of the first projection, and the first protrusion is engaged with a front side of the second projection; and in the third engaging state, the first protrusion is engaged with a back side of the second projection.

According to the fifth aspect of the invention, the second protrusion and the third protrusion, and the first projection and the second projection interposed between the insertion member and the leg portion, so that the individual engaging states can be realized by the relatively simple structure. Moreover, the first protrusion, the second protrusion and the third protrusion, which are disposed at one of the insertion member and the leg portion, are inserted slidably into the groove portions disposed at the other. As a result, those protrusions act as guides for inserting the pin-shaped member into the grommet thereby to ensure the engagements of the first, second and third engaging states.

According to the two-piece clip of the invention, the pin-shaped member is inserted so far into the grommet that the sliding protrusion reach the open portion, and the leg portion of the grommet are inserted in that state into the mounting hole of the mounting object member. Then, the elastic engagement member passes, while being warped to the inner side, through the mounting hole, and comes into engagement with the back side peripheral edge of the mounting hole. Thus, the mounting object member is clamped between the flange portion to engage with the surface side peripheral edge of the mounting hole and the elastic engagement member to engage with the back side peripheral edge of the mounting hole, so that the two-piece clip can be fixed in the mounting object member.

When it is desired to remove the clip, moreover, the pin-shaped member is extracted from the grommet. Then, the sliding protrusion moves the second slope portion so that the elastic engagement member is gradually warped inward of the leg portion. Then, the sliding protrusion abuts against the crest portion so that the elastic engagement member can be warped inward to the maximum. In this state, the elastic engagement member is warped inward to an extent not to engage with the mounting hole, so that the leg portion of the grommet can be smoothly extracted to remove the clip easily.

### BRIEF DESCRIPTION OF THE DRAWINGS

These and other objects and advantages of this invention will become more fully apparent from the following detailed description taken with the accompanying drawings in which:

FIG. 1 is an exploded perspective view showing one mode of embodiment of a two-piece clip of the invention;

FIGS. 2A and 2B show a grommet configuring the two-piece clip, and present a side elevation at FIG. 2A and a front elevation at FIG. 2B;

FIG. 3 is a top plan view of the grommet configuring the two-piece clip;

FIGS. 4A and 4B show the grommet of the two-piece clip, and present a section along line A-A of FIG. 3 at FIG. 4A and a section along line B-B of FIG. 3 at FIG. 4B;

FIGS. 5A to 5C show a pin-shaped member configuring the two-piece clip, and present a front elevation at FIG. 5A, a side elevation at FIG. 5B and a bottom view at FIG. 5C;

FIGS. 6A and 6B show a pin-shaped member configuring the two-piece clip, and present a section taken along line C-C of FIG. 5C at FIG. 6A and a section taken along line E-E of FIG. 5C at FIG. 6B;

FIGS. 7A and 7B show a state to begin the insertion of the pin-shaped member into the grommet, and present a section of the case taken in one direction at FIG. 7A and a section taken in a direction perpendicular to that of FIG. 7A at FIG. 7B;

FIGS. 8A and 8B show the state, in which the pin-shaped member of the two-piece clip is inserted into the grommet, and present a section of the case taken in one direction at FIG. 8A and a section taken in a direction perpendicular to that of FIG. 8A at FIG. 8B;

FIGS. 9A and 9B show the state, in which the pin-shaped member of the two-piece clip is inserted into the grommet, and present a section of the case taken in one direction at FIG. 9A and a section taken in a direction perpendicular to that of FIG. 9A at FIG. 9B;

FIGS. 10A and 10B show the state, in which the pin-shaped member of the two-piece clip is inserted into the grommet, in which the two-piece clip is mounted in a mounting object member and in which the engagement by a third engaging member is made, and present a section of the case taken in one direction at FIG. 10A and a section taken in a direction perpendicular to that of FIG. 10A at FIG. 10B; and

FIG. 11 is an explanatory view showing the case, in which the two-piece clip is fixed in a mounting object member having a small thickness and the case, in which the is fixed in a mounting object member having a large thickness.

### DETAILED DESCRIPTION OF THE EMBODIMENTS

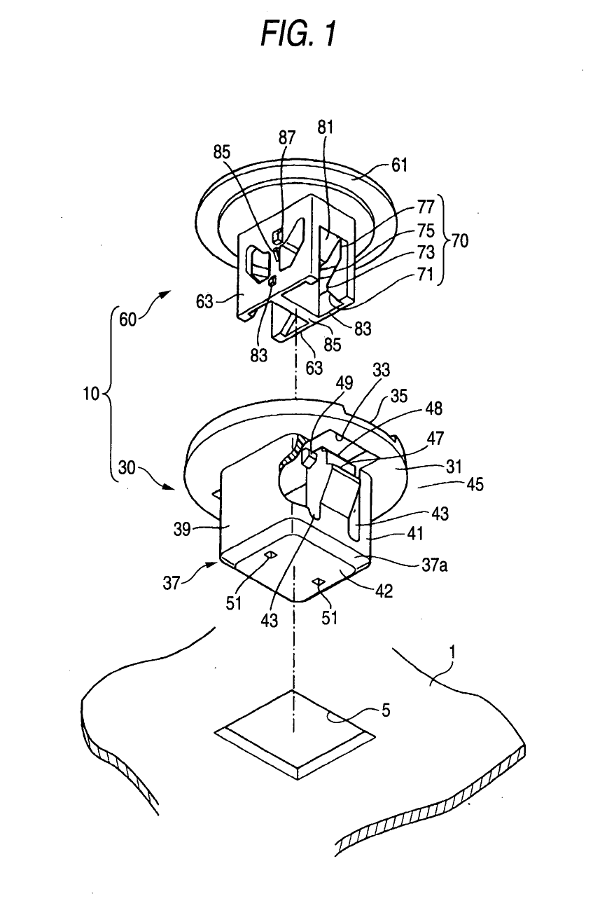

One mode of embodiment of a two-piece clip of the invention is described in the following with reference to FIGS. 1 to 11.

As shown in FIG. 1, this two-piece clip 10 (as will be called the “clip 10”) is fixed in a rectangle-shaped mounting hole 5 formed in a mounting object member 1. The clip 1 is configured of a grommet 30 and a pin-shaped member 60 to be inserted into and extracted from the grommet 30. In the configuration of this mode of embodiment, the two-piece clip 1 is merely mounted in the mounting object member 1. However, the clip 1 can also be used for fixing an interior member (such as a garnish or a trim board) on the mounting object member such as a panel member of an automobile or for connecting a plurality of panel members.

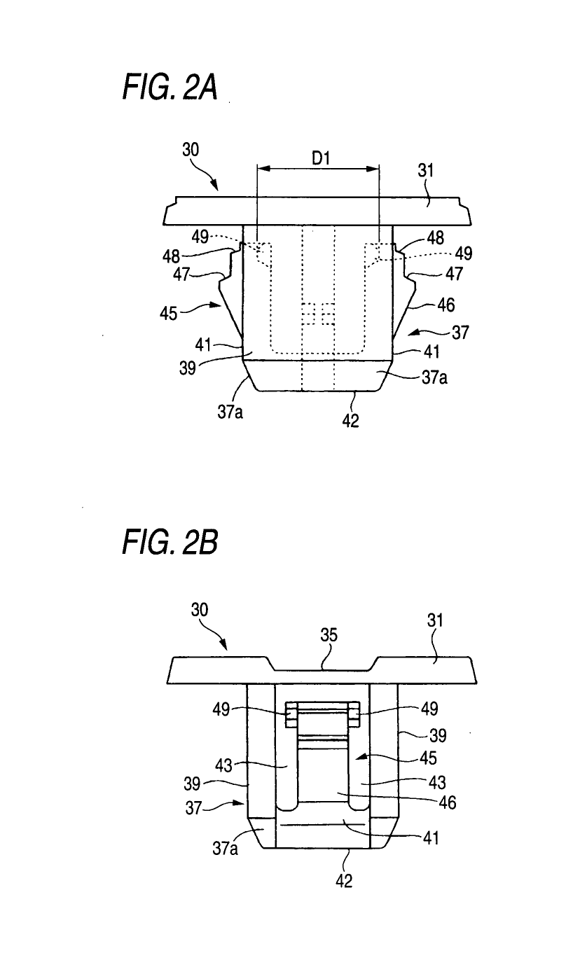

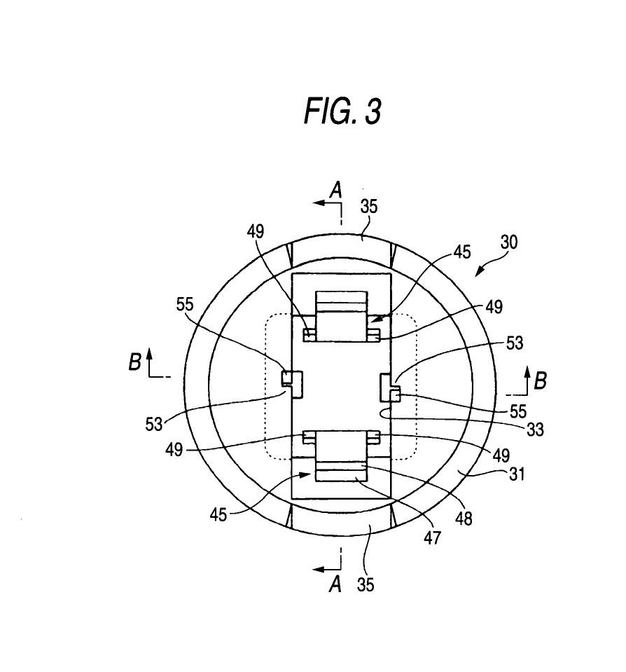

With reference to FIGS. 2A to 4B, the grommet 30 configuring the clip 1 has an annular flange portion 31 to abut against the surface-side peripheral edge of the mounting hole of the mounting object member 1. In this flange portion 31, there is formed a generally rectangular insertion hole 33, into which the pin-shaped member 60 is inserted. Moreover, the upper face (or on the insertion side of the pin-shaped member 60) of the flange portion 31 is slightly recessed in its inner side to form a pair of confronting tool tip grooves 35 and 35 (as referred to FIG. 3) in the outer peripheral edge portions of the two end sides in the longitudinal direction of the insertion hole 33. Here, the flange portion 31 may abut either directly against the surface side circumferential edge of the mounting hole 5 of the mounting object member 1 or indirectly through a trim member, if arranged on the upper face of the mounting object member 1, against the surface side circumferential edge of the mounting hole 5.

From the peripheral edge of the through hole 33 in the lower face of the flange portion 31, on the other hand, there is extended a bottomed rectangular leg portion 37, which is formed of a plurality of side walls. Specifically, this leg portion 37 is composed of a pair of side walls 39 and 39 rising in a confronting manner from the longitudinal peripheral edge of the insertion hole 33, a pair of side walls 41 and 41 connecting the end portions of those side walls 39 and 39 to each other, and a bottom wall 42 connecting the lower end portions of those side walls. Moreover, the portions connecting the peripheral edge of the bottom wall 42 and the individual side walls are so chamfered at 37a as to ensure the insertability of the leg portion 37 into the mounting hole 5.

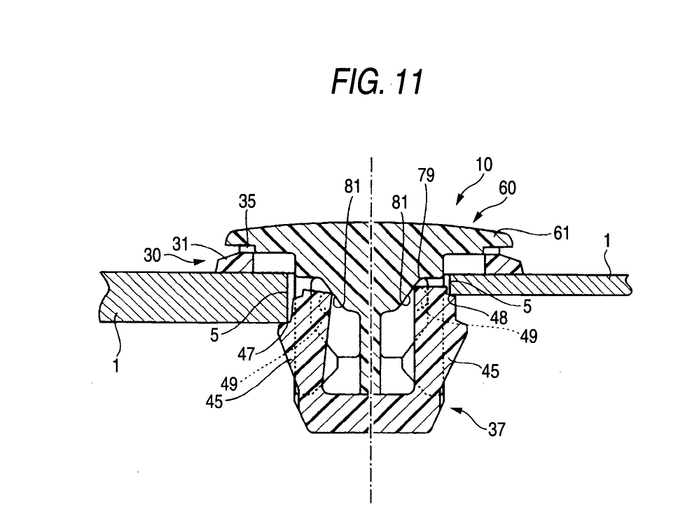

In the paired confronting side walls 41 of the leg portion 37, as shown in FIGS. 2A and 2B, there are individually formed C-shaped slits 43, which individually form elastic engagement members 45 enabled to be warped inward and outward of the leg portion 37. These elastic engagement members 45 are connected at their root portion sides to the bottom wall 42 to have a shape protruding toward the flange portion 31. Moreover, the elastic engagement members 45 are formed, on the outer sides of their root portion sides, with outward protruding faces 46, which gradually protrude outward as they come closer to the flange portion 31, so that the elastic engagement members 45 can be easily inserted into the mounting hole 5. On the side of the flange portion 31 closer to the outward protruding faces 46 and on the outer sides of the leading end portions of the elastic engagement members 45, there are formed lower step portions 47 and upper step portions 48. Of these, as shown in FIG. 11, the upper step portions 48 come into engagement (as referred to the right side of FIG. 11) with the back side peripheral edges of the mounting hole 5, in case the mounting object member 1 is thin, and the lower step portions 47 come into engagement (as referred to the left side of FIG. 11) with the back side peripheral edges of the mounting hole 5, in case the mounting object member 1 is thick. Thus, the engagement positions can be changed according to the thickness of the mounting object member 1.

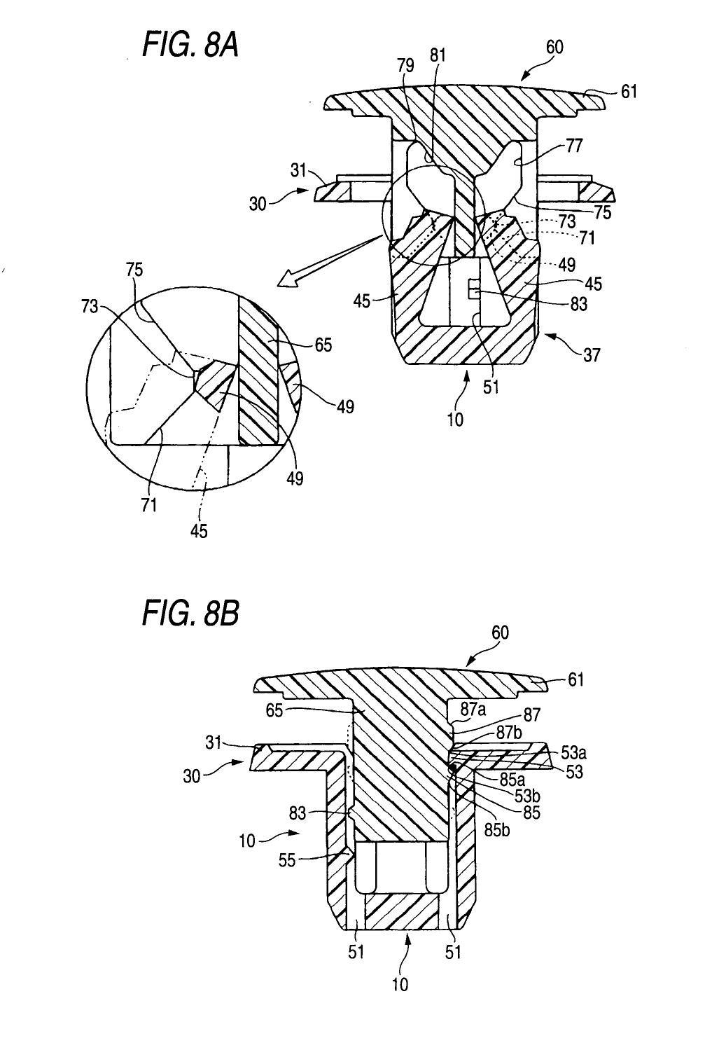

Moreover, A pair of sliding protrusions 49 and 49 are protruded from the two widthwise side portions of the leading end portions of the individual elastic engagement members 45. Each sliding protrusion 49 has a generally trapezoidal section, as viewed sideways in partially enlarged views of FIG. 2A and FIGS. 8A and 8B, and is formed closer to the inner side of the elastic engagement member 45.

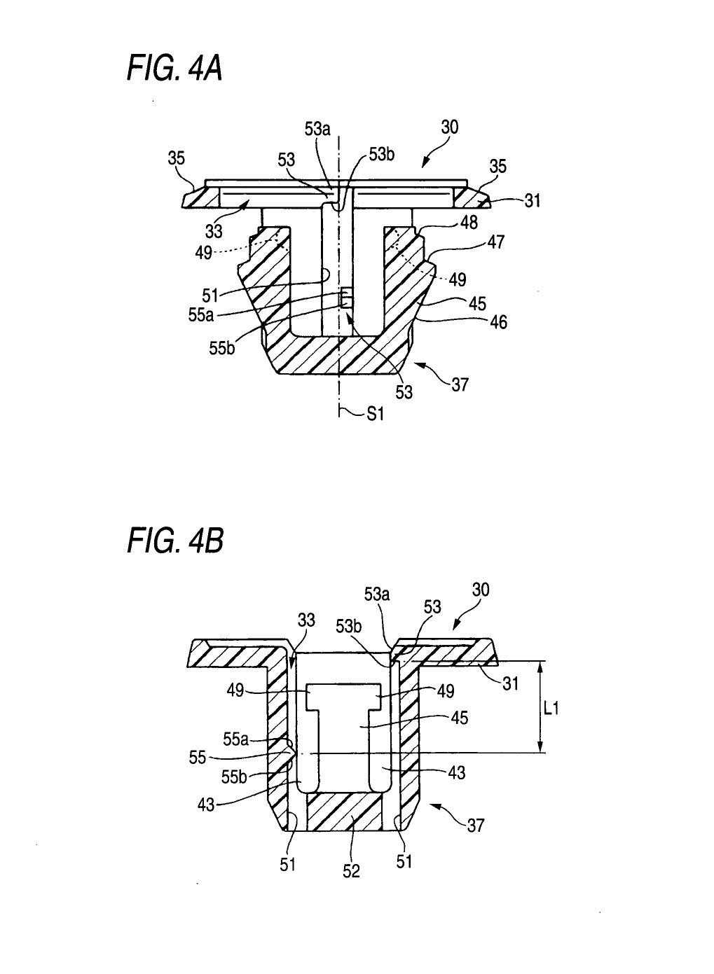

As shown in FIG. 3 and FIGS. 4A and 4B, moreover, groove portions 51 of a predetermined depth are formed in the inner sides of the side walls 39 and 39 not having the elastic engagement members 45 and at their widthwise central portions. The groove portions 51 are extended along the direction (as will be called the “direction to push the pin-shaped member”), in which the pin-shaped member 60 is pushed into the grommet 30. These groove portions 51 communicate at their one-side ends with the insertion hole 33 of the flange portion 31 and extend through a bottom wall 52 at their other ends.

On the inner side of each groove portion 51, moreover, there are formed a first projection 53 and a second projection 55, which are spaced at a predetermined spacing along the direction to push the pin-shaped member. With reference to FIGS. 4A and 4B, the first projection 53 and the second projection 55 are transversely separated with respect to a widthwise center line S1 of the groove portion 51 so that they can be molded by a vertically divided mold. The first projection 53 is so formed on the inner circumference of the flange portion 31 as to protrude within the groove width from one side portion of the groove portion 51. A tapered portions 53a is formed on the upper face of the first projection 53, and an engaging face 53b is formed on the lower face. On the other hand, the second projection 55 is so formed on the more leading end side of the leg portion 37 than the first projection 53 as to protrude into the groove width from the side portion on the side opposed to the first projection 53 of the groove portions 51. This second projection 55 is formed into a mountain shape composed of an upper taper face 55a and a lower taper face 55b, as seen in the longitudinal section of the side wall 39 in FIG. 4B. Here, FIGS. 4A and 4B show only the projections 53 and 55 formed on the groove portion 51 formed in one side wall 39, but a similar groove portion 51 and individual projections 53 and 55 are also formed at the other confronting side wall 39.

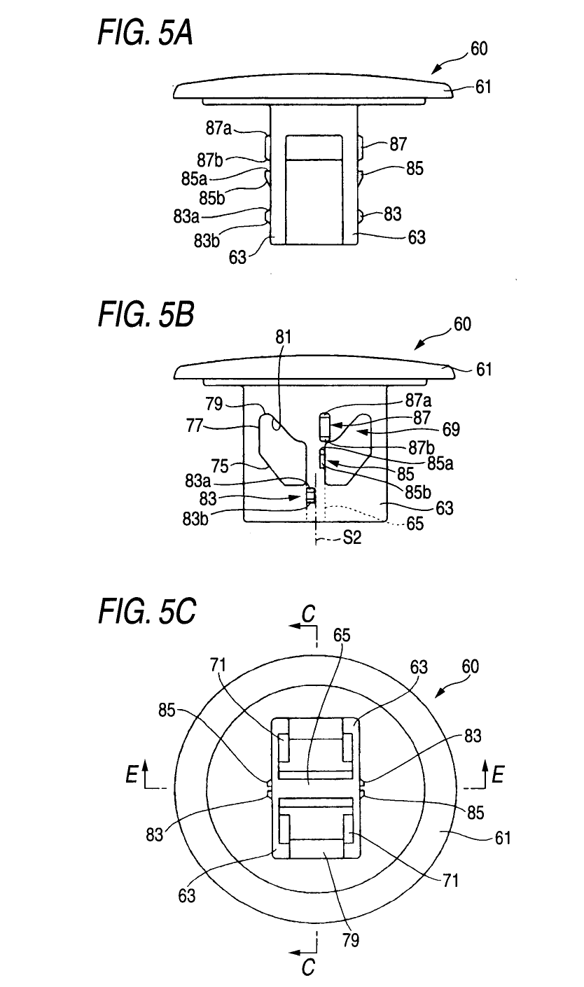

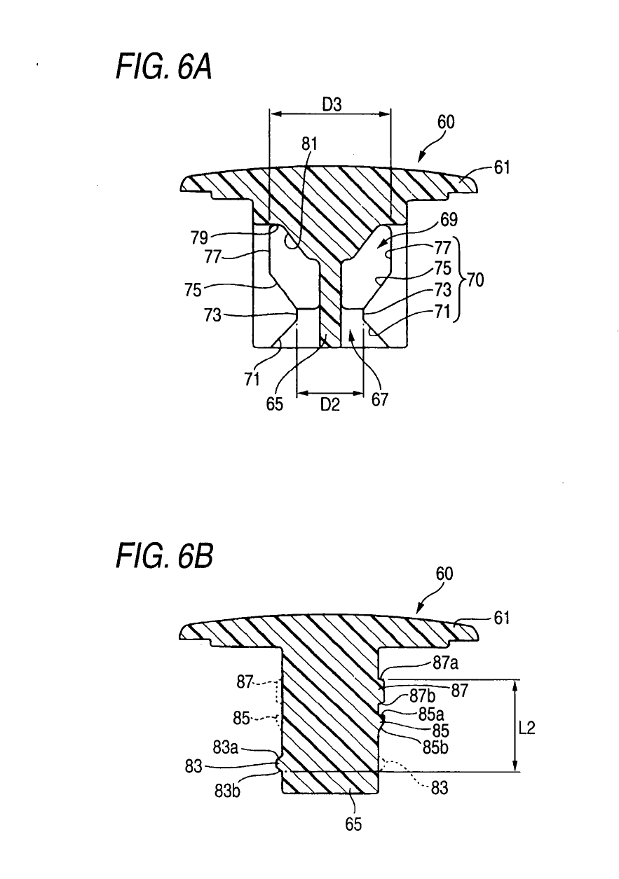

Next, the pin-shaped member 60 to be mounted in the grommet 30 thus far described is explained with reference to FIGS. 5A to 5C and FIGS. 6A and 6B.

This pin-shaped member 60 includes a disc-shaped head portion 61 having such an external diameter as fits the flange portion 31 of the aforementioned grommet 30. From the lower face of the head portion 61, there extend at a predetermined spacing and in parallel a pair of insertion members 63 and 63, which are to be inserted into the slits 43 and 43 formed on the two side portions of the aforementioned elastic engagement members 45. Moreover, the individual insertion members 63 and 63 are so connected at their widthwise central portions by a connecting wall 65 as to form a general H-shape, as viewed in the axial direction in FIG. 1 and FIG. 5C.

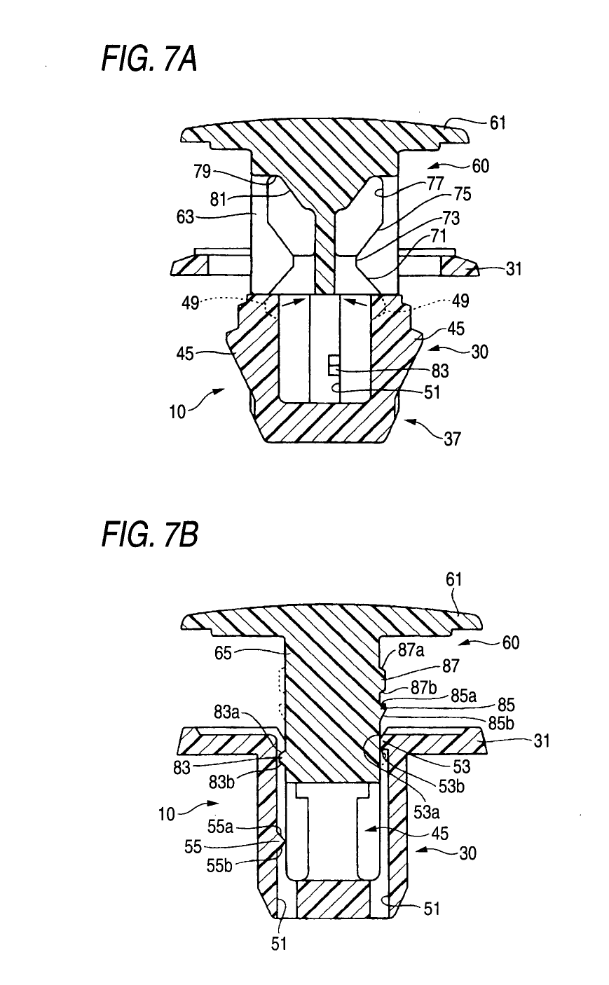

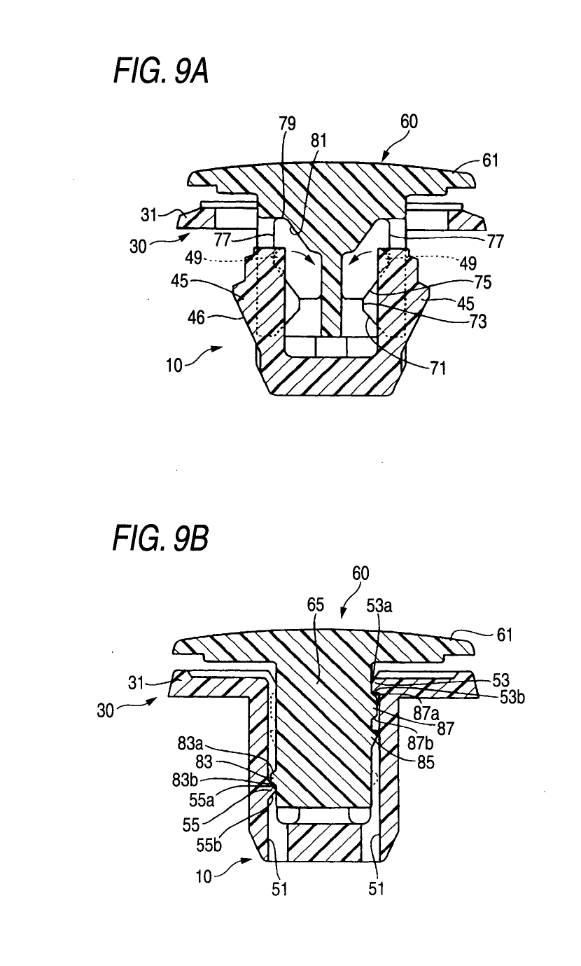

In the inner side faces of the individual insertion members 63, there are formed notched grooves 67, which are positioned in the two sides of the connecting wall 65 and diverge toward the lower side of the insertion members 63. On the outer sides of the notched grooves 67, moreover, there are formed cams 70, against which the sliding protrusions 49 of the elastic engagement members 45. With reference to FIG. 6A, the cam 70 is provided, from the leading end side to the root end side of the insertion member 63, with: first slope portions 71 (as referred to FIG. 7A) sloped for guiding the sliding protrusions 49 inward of the leg portions 37, crest portions 73 (as referred to FIG. 8A) for positioning the sliding protrusions 49 the most inside of the leg portions 37, second slope portions 75 (as referred to FIG. 9A) sloped for guiding the sliding protrusions 49 outward of the leg portions 37 to the outside of the leg portion 37, and open portions 77 extending by a predetermined length in the axial direction of the insertion members 63 from the trailing ends of the second slope portions 75. The second slope portions 75 and the open portions 77 are adjacent to through holes 69 formed on the two sides of the connecting wall 65 of the insertion members 63 thereby not to obstruct to the actions, in which the elastic engagement members 45 are warped to the inner side to move the sliding projections inward.

Moreover, the distance D1 (as referred to FIG. 2A) between the sliding protrusions 49 is set larger than the distance D2 (FIG. 6A) between the crest portions 73 of the cam 70. When the pin-shaped member 60 is inserted into the grommet 30, therefore, the sliding protrusions 49 of the elastic engagement members 45 abut against the first slope portions 71, the crest portions 73, the second slope portions 75 and the open portions 77 sequentially in the recited order so that the elastic engagement members 45 are warped inward and then opened again outward. When the sliding protrusions 49 are positioned in the open portions 77, moreover, the elastic engagement members 45 can be opened to the maximum and can also be freely warped to the inner side.

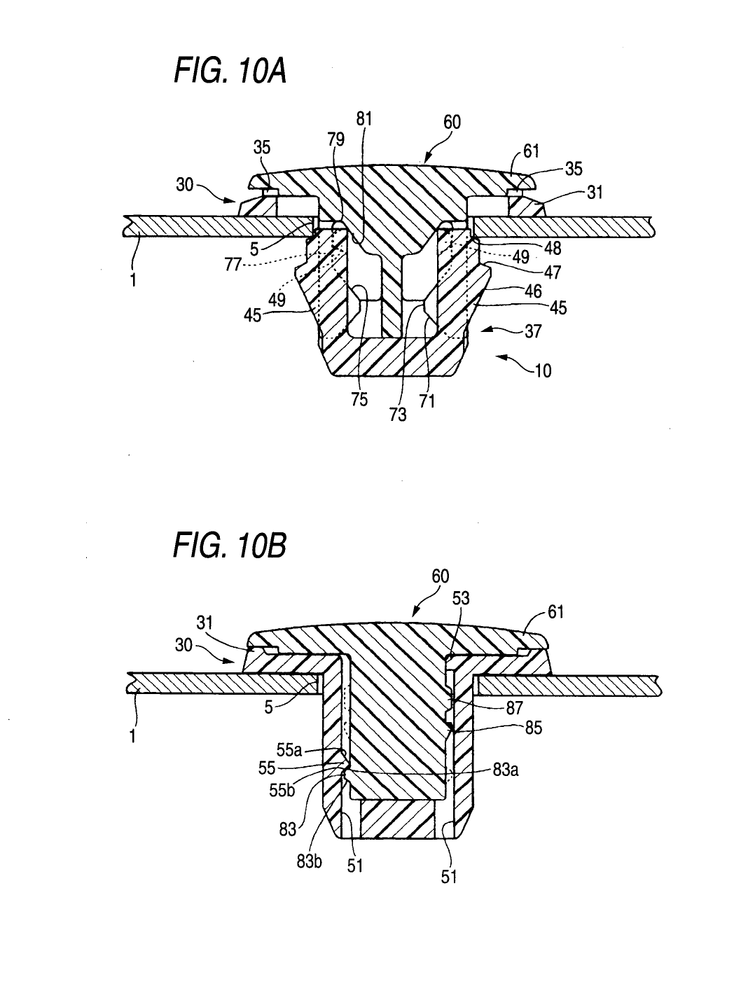

Moreover, the root portion of the connecting wall 65 for connecting the individual insertion members 63 has a tapered wall gradually enlarged in diameter toward the head portion 61 to configure a lock portion 81. As shown in FIG. 10A, the lock portion 81 comes, when the pin-shaped member 60 is pushed to the maximum into the grommet 30, into abutment against the inner side of the elastic engagement members 45 thereby to regulate the inward warpage of the elastic engagement members 45.

At the widthwise central portion of the outer side faces of the individual insertion members 63, as shown in FIGS. 5A to 5C and FIGS. 6A and 6B, first protrusions 83, second protrusions 84 and third protrusions 85 are formed at predetermined distances along the pushing direction of the pin-shaped member from the leading end side to the root end side of the insertion members 63. In this case, the first protrusions 83 and the second protrusions 85 are arranged on the right side with respect to the center line S2 of the insertion members 63, and the third protrusions 87 are arranged on the left side. These first protrusions 83, second protrusions 85 and third protrusions 87 are inserted, when the pin-shaped member 60 is pushed into the grommet 30, into the groove portions 51 of the grommet 30 so that the first protrusions 83 engage with the second projections 55 and so that the second protrusions 85 and the third protrusions 87 engage with the first projections 53.

Specifically, the first protrusion 83 is formed on its two upper and lower faces with an upper tapered face 83a and a lower tapered face 83b, respectively. Moreover, the second protrusion 85 is formed on its upper face with an engaging face 85a normal to the axial direction of the insertion member 63, and on its lower face with a tapered face 85b. Moreover, the third protrusion 87 is formed on its two upper and lower faces with an upper tapered face 87a and a lower tapered face 87b, respectively. As shown in FIG. 6B, the distance L2 from the upper tapered face 87a of the third protrusion 87 to the lower tapered face 83b of the first protrusion 83 is set equal to or slightly shorter than the distance L1 (as shown in FIG. 4B) from the engaging face 53b of the aforementioned first projection 53 to the lower end of the upper tapered face 55a of the second projection 55.

When the pin-shaped member 60 is pushed and pulled with respect to the grommet 30, the aforementioned individual protrusions 85 and 87 engage at predetermined positions with the respective projections 53 and 55 of the grommet 30 thereby to hold the pin-shaped member 60 at the predetermined position with respect to the grommet 30.

As shown in FIG. 8B, the lower tapered face 87b of the third protrusion 87 and the engaging face 85a of the second protrusion 85 engage with the upper tapered face 53a and the engaging face 53b (i.e., the fronts and the backs of the first projections in the invention) of the first projection 53. As shown in FIG. 8A, the pin-shaped member 60 is tentatively held in the grommet 30 so that the sliding protrusions 49 are positioned on the crest portions 73 of the cams 70. At this time, the first projection 53, the second protrusions 85 and the third protrusions 87 configure first engaging portions (a first engaging state).

As shown in FIG. 9B, moreover, the upper tapered faces 87a of the third protrusions 87 engage with the engaging faces 53b (or the backs of the first projections in the mode of embodiment) of the first projections 53, and the lower tapered faces 83b of the first protrusions 83 engage with the upper tapered faces 55a (or the fronts of the second projections in the invention) of the second projections 55. As a result, the pin-shaped member 60 is tentatively held in the grommet 30 such that the sliding protrusions 49 are positioned on the open portions 77 of the cams 70 and such that the lock portion 81 does not contact with the elastic engagement members 45, as shown in FIG. 9A. At this time, the first projections 53 and the third protrusions 87, and the second projections 55 and the first protrusions 83 configure second engaging portions (a second engaging state).

As shown in FIG. 10B, moreover, the upper tapered faces 83a of the third protrusions 83 engage with the lower taper faces 55b (or the backs of the second projections in the mode of embodiment) of the second projections 55. As a result, the pin-shaped member 60 is held in the grommet 30 such that the sliding protrusions 49 are positioned on the open portions 77 of the cams 70 and such that the lock portion 81 contacts with the elastic engagement members 45. At this time, the second projections 55 and the first protrusions 83 configure third engaging portions (a third engaging state).

While the pin-shaped member 60 is being tentatively held with respect to the grommet 30, as shown in FIG. 9B, the holding force at this time by the second engaging portions is set stronger than the resisting force which is generated by the sliding contact between the elastic engagement members 45 and the inner periphery of the mounting hole 5 at the time when the leg portion 37 of the grommet 30 is pushed while pushing the pin-shaped member 60 into the mounting hole 5 of the mounting object member 1.

The method of using the clip 10 thus far described is explained in the following.

At first, when the clip 10 is mounted, the paired insertion members 63 and 63 of the pin-shaped member 60 are positionally adjusted to the slits 43 and 43 formed in the grommet 30, as shown in FIG. 1, and the pin-shaped member 60 is pushed into the grommet 30. As shown in FIG. 7A, the sliding projections 49 abut against the first slope portions 71 of the cams 70, and the sliding protrusions 49 move along the first slope portions 71 while the elastic engagement members 45 are warped inward of the leg portions 37. At this time, the individual protrusions 83, 85 and 87 of the pin-shaped member 60 are inserted into the groove portions 51 of the grommet 30, as shown in FIG. 7B, so that they slide along the direction to push the pin-shaped member. Thus, the individual protrusions 83, 85 and 87 can be slidably inserted into the groove portions 51 so that the pin-shaped member 60 can be guided and smoothly inserted into the grommet 30 while ensuring the engagement with the individual projections 53 and 55.

When the sliding protrusions 49 reach the crest portions 73 of the cams 70, the elastic engagement members 45 are warped inward of the leg portions 37 to the maximum, as shown in FIG. 8A. Here, the partially enlarged diagram in FIG. 8A presents a section cut at the portion of the sliding protrusions 49. At this time, moreover, the first projections 53 ride over the second protrusions 85 while sliding on the tapered faces 85b of the second protrusions 85, and go between the second protrusions 85 and the third protrusions 87 so that the lower tapered faces 87b of the third protrusions 87 and the engaging faces 85a of the second protrusions 85 engage with the upper tapered faces 53a and the engaging faces 53b of the first projections 53, as shown in FIG. 8B. As a result, while the sliding protrusions 49 being position on the crest portions 73 of the cams 70, as shown in FIG. 8A, the pin-shaped member 60 is tentatively held by the grommet 30. What has been described hereinbefore is the engagement by the first engaging portions in the invention. As has been described, the distance D1 between the individual sliding protrusions is set larger than the distance D2 between the crest portions 73 and 73, but the distances D1 and D2 are set such that the elastic engagement members 45 are so warped inward in the aforementioned state as not to engage with the peripheral edge of the back side of the mounting hole 5.

When the pin-shaped member 60 is further pushed from the aforementioned state, the sliding protrusions 49 abut against the second slope portions 77 of the cams 70, as shown in FIG. 9A, so that the elastic engagement members 45 again begin to open outward of the leg portions 37. When the sliding protrusions 49 move along the second slope portions 77 to the open portions 77, the elastic engagement members 45 are opened outward to the maximum while the leg portions 37 being capable of being warped inward. At the same time, the first projections 53 come out from between the second protrusions 85 and the third protrusions 87 while sliding contact on the lower tapered faces 87b of the third protrusions 87. As shown in FIG. 9B, the upper tapered faces 87a of the third protrusions 87 engage with the engaging faces 53b of the first projections 53, and the lower tapered faces 83b of the first protrusions 87 engage with the upper tapered faces 55a of the second projections 55, so that the pin-shaped member 60 is tentatively held, in the state shown in FIG. 9A, in the grommet 30. What has been described hereinbefore is the engagement by the second engaging portions in the invention.

With the pin-shaped member 60 being tentatively held in the grommet 30 by the second engaging portions, as described above, the grommet 30 is inserted while pushing the pin-shaped member 60 from the surface side of the mounting hole 5 of the mounting object member 1. The outward protruding faces 46 are pushed onto the inner periphery of the mounting hole 5, and the elastic engagement members 45 are warped inward of the leg portions 37, so that the lower step portions 47 or the upper step portions 48 of the elastic engagement members 45 engage with the peripheral edge of the back side of the mounting hole 5 in accordance with the thickness of the mounting object member 1 (as referred to FIG. 11). In the case of this mode of embodiment, the upper step portions 48 engage, as shown in FIGS. 10A and 10B. Thus, the flange portion 31 of the grommet 30 engages with the peripheral edge of the surface side of the mounting hole 5, and the upper step portions 48 of the elastic engagement members 45 engage with the peripheral edge of the back side of the mounting hole 5. The mounting object member 1 can be clamped between the flange portion 31 and the elastic engagement members 45 to fix the clip 10 in the mounting object member 1.

At this time, the holding force by the second engaging portions in the mode where the pin-shaped member 60 is tentatively held by the grommet 30, as shown in FIG. 9B, is set stronger than the resisting force, which is generated by the sliding contact between the elastic engagement members 45 and the inner periphery of the mounting hole 5 of the mounting object member 1 at the time the leg portions 37 of the grommet 30 are pushed into the mounting hole 5 while pushing the pin-shaped member 60 in that state. Even if the pin-shaped member 60 is pushed to insert the grommet 30 into the mounting hole 5, therefore, the pin-shaped member 60 is not completely pushed into the grommet 30, but the elastic engagement members 45 can be warped inward to engage through the mounting hole 5 with the back side peripheral edge of the mounting hole 5 thereby to fix the grip 10.

Here in the aforementioned state, the sliding protrusions 49 are positioned in the open portions 77 of the cam 70, and the elastic engagement members 45 may be warped inward. If, therefore, the pin-shaped member 60 is further pushed to the maximum into the grommet 30, the first protrusions 83 ride, while sliding on the upper tapered faces 55a of the second projections 55, over the second projections 55 so that the upper tapered faces 83a of the first protrusions 83 engage with the lower tapered faces 55b of the second projections 55, as shown in FIG. 10B. At the same time, the lock portion 81 abuts against the inner sides of the elastic engagement members 45, as shown in FIG. 10A, to establish the state, in which the inward warpage of the elastic engagement members 45 is regulated. Even if the force or the like transverse to the mounting hole 5 acts on the clip, the elastic engagement members 45 are not warped inward so that the clip 10 can be reliably kept in the fixed state while being prevented from rattling or coming out.

In case it is desired to remove the clip 10 from the mounting object member 1, moreover, a tool such as a minus driver is inserted into the tool tip groove and used like a lever to force-open the head portion 61 thereby to extract the pin-shaped member 60 from the grommet 30. Then, the sliding protrusions 49 move the second slope portions 75 backward of the aforementioned direction so that the elastic engagement members 45 are gradually warped inward of the leg portions 37. Then, the sliding protrusions 49 abut against the crest portions 73 so that the elastic engagement members 45 are warped inward to the maximum. In this state, the first projections 53 go between the second protrusions 85 and the third protrusions 87 so that the lower tapered faces 87b of the third protrusions 87 and the engaging faces 85a of the second protrusions 85 engage with the upper tapered faces 53a and the engaging faces 53b of the first projections 53, respectively, as shown in FIG. 8B. Thus, the pin-shaped member 60 can be again tentatively held in the state (i.e., the engagement by the first engaging portions) shown in FIG. 8A in the grommet 30. In this state, moreover, the elastic engagement members 45 are warped inward to an extent not to engage with the mounting hole 5, as has been described hereinbefore, so that the leg portions 37 of the grommet 30 can be smoothly extracted to remove the clip 10 easily.

Here in the mode of embodiment thus far described, the leg portions 37 of the grommet 30 are provided with the groove portions 51 and the individual projections 53 and 55, and the insertion members 63 of the pin-shaped member 60 are provided with the individual protrusions 83, 85 and 87. However, the insertion members 63 may be provided with the groove portions 51 and the individual projections 53 and 55, and the leg portions 37 may be provided with the individual protrusions 83, 85 and 87.

What is claimed is:

1. A two-piece clip comprising:
a grommet; and
a pin-shaped member adapted to be inserted into and extracted from the grommet, wherein:
the grommet includes: a flange portion abutting against a surface side peripheral edge of a mounting hole formed in a mounting object member and having an insertion hole that the pin-shaped member is inserted; a leg portion extending in a cylindrical shape from the insertion hole peripheral edge of the flange portion; an elastic engagement member formed on at least one side walls of the leg portion through slit as to be warped to the inner side and the outer side of the leg portion, the elastic engagement member engaging with a back side peripheral edge of the mounting hole; and a sliding protrusion protruding from at least one side portion of the elastic engagement member;
the pin-shaped member includes an insertion member to be inserted into the slit that is related to the sliding protrusion of the leg portion;
the insertion member is provided on an inner side face with a cam;
the cam includes: a first slope portion sloped for guiding the sliding protrusion inward of the leg portion; a crest portion at the trailing end of the first slope portion for positioning the sliding protrusion to the most inside of the leg portion; and a second slope portion sloped for guiding the sliding protrusion outward of the leg portion; and an open portion for not regulating the sliding protrusion;
the first slope portion, the crest portion, the second slope portion and the open portion are continuously formed from a leading end side to a root end side of the insertion member; and
when the sliding protrusion is positioned at the crest portion, the elastic engagement member is warped so inward as unengaged with the mounting hole.

2. The two-piece clip according to claim 1, wherein
in a first engaging state, the pin-shaped member is tentatively held in the grommet in a state where the pin-shaped member is pushed into the grommet so that the sliding protrusion is positioned at the crest portion.

3. The two-piece clip according to claim 2, further comprising
a lock portion for abutting against the elastic engagement member thereby to regulate an inward warpage of the elastic engagement member when the pin-shaped member is pushed to the maximum into the grommet, the lock portion being provided with the pin-shaped member.

4. The two-piece clip according to claim 3, wherein:
in a second engaging state, the pin-shaped member is tentatively held in the grommet in the state where the sliding protrusion is positioned at the open portion and where the lock portion does not abut against the elastic engagement member;
in a third engaging state, the pin-shaped member is held in the grommet in the state where the sliding protrusion is positioned at the open portion and where the lock portion abuts against the elastic engagement member; and
the holding force corresponding to the second engaging state is set stronger than the resisting force, which is generated by the sliding contact between the elastic engagement member and an inner periphery of the mounting hole when the leg portion of the grommet is pushed while pushing the pin-shaped member into the mounting hole in the state where the pin-shaped member is tentatively held in the grommet in the second engaging state.

5. The two-piece clip according to claim 4, further comprising:
a first protrusion;
a second protrusion;
a third protrusion;
a first projection; and
a second projection, wherein:
one of the insertion member and the leg portion includes the first protrusion, the second protrusion and the third protrusion formed at a predetermined spacing along the pushing direction from the leading end side of the insertion member or the root end side of the leg portion;
the other of the insertion member and the leg portion includes groove portions, into which the first protrusion, the second protrusion and the third protrusion are slidably inserted, and the first projection and the second projection, which are formed on the inner side of the groove portions at a predetermined spacing along the pushing direction from the leading end side of the insertion member or the root end side of the leg portion;
in the first engaging state, the third protrusion is engaged with a front side of the first projection, and the second protrusion are engaged with a back side of the first projection;
in the second state, the third protrusion is engaged with the back side of the first projection, and the first protrusion is engaged with a front side of the second projection; and
in the third engaging state, the first protrusion is engaged with a back side of the second projection.
